(19) United States
(12) Patent Application Publication
(10) Pub. No.: US 2026/0359581 A1
(43) Pub. Date: Nov. 12, 2026

(54) SYNTHESIZED SPEECH FOR LANGUAGE TRANSLATION IN A VIRTUAL MEETING

(71) Applicant: Google LLC, Mountain View, CA (US)

(72) Inventors: Huib Victor Kleinhout, Slattum (NO); Maria Josefin Karlsson, Stockholm (SE); Ryan Thomas Fedyk, New York City, NY (US); Esbjörn Dominique, Stockholm (SE)

(21) Appl. No.: 19/205,763

(22) Filed: May 12, 2025

(51) Int. Cl. G06F 40/58; H04N 7/15

(52) U.S. Cl. CPC G06F 40/58; H04N 7/157

(57) ABSTRACT

A system and method for synthesized speech for language translation in virtual meetings, the operations including: receiving, during a virtual meeting, media stream portions which include audio portions in a first language. The audio portions in the first language are to be translated to a second language. Determining whether a first audio portion satisfies one or more translation sufficiency criteria. Responsive to determining that the first audio portion satisfies the one or more translation sufficiency criteria, providing the first audio portion as input to an artificial intelligence (AI) model trained to translate speech in the first language into speech in the second language. Obtaining, from the AI model, a first output including the first audio portion in the second language. Providing, during the virtual meeting, the first audio portion in the second language to a device of a user participating in the virtual meeting.

### TECHNICAL FIELD

Aspects and implementations of the present disclosure relate to synthesized for language translation in a virtual meeting.

### BACKGROUND

Virtual meeting participants can join a virtual meeting from most locations where a computing device can connect to a network. Participants who participate in a virtual meeting may speak different languages.

### SUMMARY

The following is a simplified summary of the disclosure in order to provide a basic understanding of some aspects of the disclosure. This summary is not an extensive overview of the disclosure. It is intended to neither identify key or critical elements of the disclosure, nor delineate any scope of the particular implementations of the disclosure or any scope of the claims. Its sole purpose is to present some concepts of the disclosure in a simplified form as a prelude to the more detailed description that is presented later.

An aspect of the disclosure provides a computer-implemented method including: receiving, during a virtual meeting, a sequence of media stream portions from a first device of a first uscr of a plurality of users participating in a virtual meeting. The sequence of media stream portions includes a first sequence of audio portions reflecting speech in a first language. The speech in the first language is to be translated to a second language for a second user of the plurality of users participating in the virtual meeting. Audio portions of the first sequence are each received at respective time points during the virtual meeting; responsive to receiving a first audio portion of the sequence of audio portions at a first time point during the virtual meeting, determining whether the first audio portion satisfies one or more translation sufficiency criteria; responsive to determining that the first audio portion satisfies the one or more translation sufficiency criteria, causing the first audio portion to be translated into the second language. Speech in the first audio portion is associated with a first set of prosodic speech elements; and providing, to a second device of the second user, first synthesized speech in the second language. The first synthesized speech is generated based on the first audio portion in the second language, and is associated with a second set of prosodic speech elements corresponding to the first set of prosodic speech elements.

In some aspects the method further includes: responsive to receiving a second audio portion of the sequence of audio portions at a second time point during the virtual meeting, determining whether the second audio portion satisfies the one or more translation sufficiency criteria; responsive to determining that the second audio portion does not satisfy the one or more translation sufficiency criteria: refraining from causing the second audio portion to be translated into the second language; responsive to receiving a third audio portion at a third time point during the virtual meeting, determining whether a combination of the second audio portion and the third audio portion satisfics the one or more translation sufficiency criteria; responsive to determining that the combination of the second audio portion and the third audio portion satisfies the one or more translation sufficiency criteria, causing the combination of the second audio portion and the third audio portion to be translated into the second language. Speech in the combination of the second audio portion and the third audio portion is associated with a third set of prosodic speech elements; and providing, to the second device of the second user, second synthesized speech in the second language. The second synthesized speech is generated based on the combination of the second audio portion and the third audio portion in the second language, and is associated with a fourth set of prosodic speech elements corresponding to the third set of prosodic speech elements.

In some aspects, the one or more translation sufficiency criteria include at least one of: a word criterion, an idiom criterion, an input duration criterion, a processing duration criterion, or a maximum delay criterion.

In some aspects, the one or more translation sufficiency criteria are based on a pairing between the first language and the second language.

In some aspects, the first synthesized speech is provided to the second device as an overlay on the speech in the first language of the first audio portion.

In some aspects, a first volume of the speech in the first language of the first audio portion is lower than a second volume of the first synthesized speech in the second language.

In some aspects, causing the first audio portion to be translated into the second language includes: providing the first audio portion as a first input to an artificial intelligence (AI) model trained to translate speech in the first language into speech in the second language; and obtaining a first output of the AI model, the first output including at least one of a first translated audio portion or the first synthesized speech.

An aspect of the disclosure provides a system including a memory and one or more processing devices communicatively coupled to the memory, the one or more processing devices to perform the method above.

An aspect of the disclosure provides a non-transitory computer-readable storage medium including instructions, that when executed by one or more processing devices cause a server to perform the method above.

### BRIEF DESCRIPTION OF THE DRAWINGS

Aspects and implementations of the present disclosure will be understood more fully from the detailed description given below and from the accompanying drawings of various aspects and implementations of the disclosure, which, however, should not be taken to limit the disclosure to the specific aspects or implementations, but are for explanation and understanding only.

FIG. 1 illustrates an example of a system, according to some aspects of the disclosure.

FIG. 2A is an example block diagram illustrating an example of a natural delay that is present when translating between languages.

FIG. 2B is an example block diagram illustrating an example of the effects of translation latency on the quality of translation from a first language to a second language.

FIG. 3A is a block diagram illustrating audio portions with a predetermined size and/or duration in a media stream, according to some aspects of the disclosure.

FIG. 3B is a block diagram illustrating audio portions with a variable size and/or duration in a media stream, according to some aspects of the disclosure.

FIG. 4 is a flow diagram of an example method for synthesized speech for language translation in virtual meetings, according to some aspects of the disclosure.

FIG. 5 is a flow diagram of an example method for synthesized speech for language translation in virtual meetings, according to some aspects of the disclosure.

FIG. 6 is a block diagram illustrating an example of a computer system, according to aspects of the disclosure.

### DETAILED DESCRIPTION

Aspects of the present disclosure relate to synthesized speech for language translation in virtual meetings. A virtual meeting can refer to a meeting that is attended by participants using respective client devices connected to a virtual meeting platform. A client device connected to the virtual meeting platform captures and transmits image data (e.g., collected by a camera of the client device) and/or audio data (c.g., collected by a microphone of the client device) that is provided to other client devices connected to the virtual meeting platform. The image data may depict a user (e.g., a participant) or a group of users that are participating in the virtual meeting. The audio data may include an audio recording of audio provided by the user or group of users during the virtual meeting. A virtual meeting platform can enable video-based conferences between multiple participants via respective client devices that are connected over a network and share each other's audio (c.g., voice of a user recorded via a microphone of a client device) and/or media streams (e.g., a video captured by a camera of a client device) during a virtual meeting. In some instances, a virtual meeting platform can enable a significant number of client devices (e.g., up to ten- thousand or more client devices) to be connected for the virtual meeting.

Virtual meetings allow participants to interact in real-time. When participants in a virtual meeting speak different languages, translation tools such as speech-to-speech translation (S2ST) can help facilitate communication. However, there is a natural latency in translating between languages. This natural latency results from linguistic differences between languages, such as variations in word order, sentence structure and/or grammar. In many instances, a direct word-for- word translation without any processing time may yield a grammatically incorrect or semantically flawed output, which may hinder communication between participants of the virtual meeting.

Furthermore, existing translation tools are typically unable to convey information such as tone, emphasis, emotion, and/or other paralinguistic cues (e.g., including prosodic elements of speech) of a speaker when translating their speech to a different language during a virtual meeting.

Aspects of the present disclosure address these and other challenges by providing synthetic translation of a speaker's voice in a target language with a minimal delay required for accurate real-time translation in a virtual meeting. A virtual meeting platform hosting the virtual meeting can enable a participant to provide and/or withdraw consent to have their speech translated at any time during the virtual meeting. The virtual meeting platform can also enable a participant to provide and/or withdraw consent to have synthetic translation of their voice to be generated and presented during the virtual meeting.

In some implementations, during a virtual meeting, media stream portions are sequentially received from a device of a user participating in the meeting. The media stream portions include corresponding audio portions containing speech in an original language (e.g., a first language), which is intended to be translated into a target language (c.g., a second language) for another participant. As a media stream portion is received, a translation system extracts a corresponding audio portion and determines whether the audio portion satisfies one or more translation criteria (e.g., whether the audio portion includes an entire idiom phrase or an entire translation unit dynamically defined for the occurring translation). If so, the translation of the audio portion into the target language is initiated. The resulting translated audio portion is then used to deliver to the second user synthesized speech that preserves prosodic elements, such as tone, emphasis, and rhythm, that are present in the original speech. If the audio portion does not satisfy the one or more translation criteria, the translation of the audio portion into the target language is not initiated until the next audio portion is received and it is determined that the combination of both portions satisfies the one or more translation criteria. The resulting translated combination of both portions is then used to deliver to the second user synthesized speech that preserves prosodic elements, such as tone, emphasis, and rhythm, that are present in the original speech.

In some implementations, the generated synthesized speech in the target language is played as an overlay on the original speech during the virtual meeting, with a delay required for obtaining sufficient context to provide accurate real-time translation, given linguistic differences between the two languages (e.g., different word order in a phrase or sentence). The delay between the original and synthesized speech can be dynamically adjusted to balance translation accuracy and user experience, depending on the linguistic context. For example, translating an entire figure of speech may result in a longer delay, while translating individual words allows for shorter delays. By dynamically selecting the size of translation units, the translation system can maintain high translation quality with relatively low latency, providing more accurate and contextually relevant translations than other near-zero latency approaches. For example, shorter latency translations (e.g., individual words) can be used to balance out longer latency translations (e.g., figures of speech, grammatical delays, etc.). Further details about a dynamically adjustable delay are provided below.

The translation system is configured to generate synthesized speech that reflects the speaker's voice and style in order to preserve the speaker's intent and/or emotion. Overlaying the translated audio portion (e.g., the synthesized speech), which mirrors the prosodic features of the original, onto the original speech with a brief delay helps to balance real-time delivery, translation quality, and the speaker identity. In some implementations, the translation system can adjust audio levels to prioritize the synthesized speech while keeping the original speech audible in the background.

Accordingly, aspects of the present disclosure provide synthetic translation of a speaker's voice in a target language with a minimal delay required for accurate real-time translation in a virtual meeting, thereby enabling a smoother conversation flow between users speaking different languages, reducing translation latency, and facilitating a stronger connection with the speaker. By overlaying the synthesized speech that preserves prosodic features onto the original speech with a brief delay, aspects of the present disclosure are able to balance real-time delivery, translation accuracy, and speaker identity. Furthermore, aspects of the present disclosure enhance clarity and reduce confusion during a virtual meeting by enabling participants to hear timely, easily attributable translations, minimizing misunderstandings about who is speaking or what is being said.

As used herein, a "translation unit" can refer to the smallest segment of a source language that is treated as a complete element when translated into a target language. Rather than translating word-by-word, a translation unit may include larger structures such as phrases, clauses, sentences, or even paragraphs, depending on how meaning is organized in the source language. For example, idioms, technical terms, or culturally specific expressions are typically considered single translation units because translating them word-for-word would not accurately convey their meaning. A translation unit can vary based on the subject matter. For example, in literary translation, a sentence or set of sentences might form a translation unit to preserve tone and style, while in technical translation, discrete terms or commands may define the translation unit. In real- time interpretation, translation units may be smaller to maintain speed and fluency.

As used herein, "prosodic elements" refers to auditory characteristics of a participant's speech, which may include, for example, one or more of a volume of speech, an intonation of speech, an articulation of speech, a speed of speech, a pronunciation of speech, a rhythm of speech, an emphasis of speech, or a pitch of speech.

As used herein, "volume" of speech refers to a loudness or intensity of a participant's voice, and can bc a measure of how forcefully air passes by the vocal cords of the participant.

As used herein, "intonation" of speech refers to a variation in pitch or melody of the participant's voice, and can represent conveyed emotions, emphasis, or parts of speech. For example, a rising intonation at the end of a sentence can indicate a question, while a falling intonation can indicate a statement or conclusion.

As used herein, "articulation" of speech refers to the clarity and precision with which a participant makes speech sounds, such as consonant or vowel sounds. Articulation of speech can be based on the movement and coordination of the tongue, lips, jaw, and other speech organs to form distinct phonetic sounds.

As used herein, "speed" of speech refers to a speech rate, or pace at which a participant speaks. The speed can refer to how fast the participant combines sounds in a word to speak the word (e.g., how fast the word is spoken) and/or how fast the participant combines words to form their speech (e.g., the length of pauses in between words), and may be measured in spoken words per minute (WPM).

As used herein, "pronunciation" of speech refers to particular sounds made by the individual participant when speaking a particular word or phoneme. Pronunciation of speech can be based on an accent of a language. For example, a participant with a British accent will pronounce words differently than a participant with an American accent, despite both attempting to speak the same English word or phrase. Pronunciation of speech can also be based on specific sounds produced by the individual when speaking a word or phoneme. For example, a participant with a lisp will pronounce words differently than a participant without a lisp.

As used herein, a "rhythm" of speech refers to a pattern of timing, pacing, and pauses in spoken language. It includes the relative duration of syllables and words, and it contributes to the natural flow and intelligibility of speech by organizing it into a predictable temporal structure.

As used herein, an "emphasis" of speech refers to increasing the loudness, pitch, or duration of a syllable or word to make it stand out from surrounding elements. This change in prominence helps signal important information, contrast, or focus within a sentence. In contrast to "intonation" of speech described above, emphasis of speech is localized to specific words, phrases or ideas, while intonation represents a global speech characteristic.

As used herein, a "pitch" of speech refers to a perceived highness or lowness of a speaker's voice, which results from the frequency of vocal cord vibrations. Changes in pitch can signal different sentence types, emotional states, or communicative intent, such as distinguishing a question from a statement.

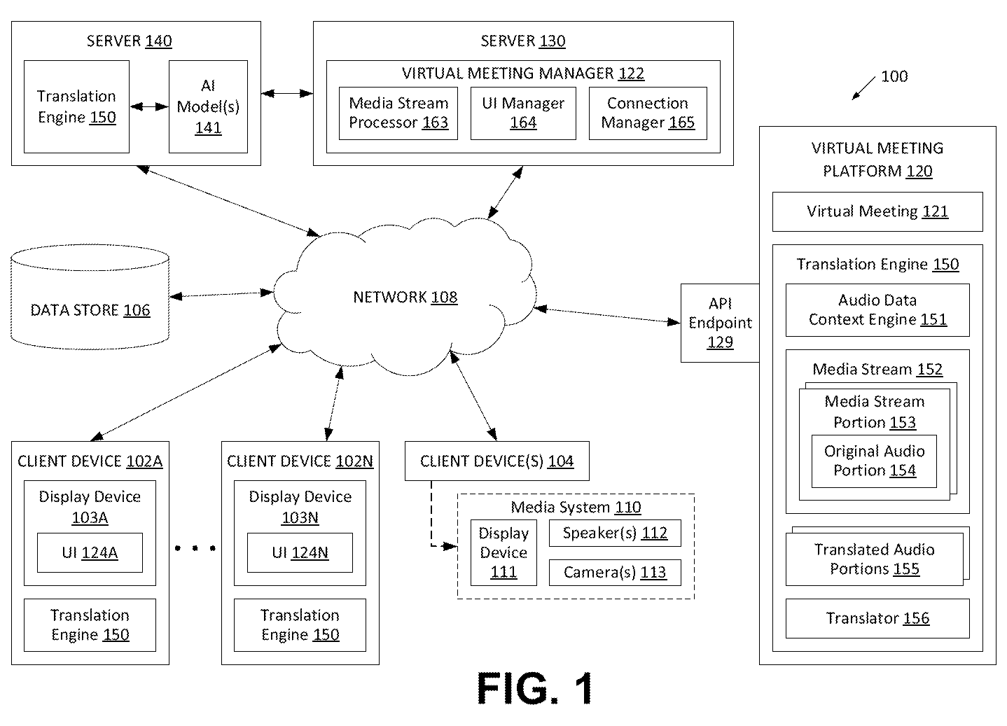

FIG. 1 illustrates an example of a system 100, according to some aspects of the disclosure. The system 100 includes client devices 102A-102N, one or more client device(s) 104, a data store 106, a virtual meeting platform 120, and a server 130, cach connected to a network 108.

In implementations, network 108 can include a public network (e.g., the Internet), a private network (e.g., a local area network (LAN) or wide area network (WAN)), a wired network (e.g., Ethernet network), a wireless network (e.g., an 802.11 network or a wireless fidelity (Wi-Fi) network), a cellular network (e.g., a Long Term Evolution (LTE) network), routers, hubs, switches, server computers, and/or a combination thereof.

Data store 106 is a persistent storage that is capable of storing data as well as data structures to tag, organize, and index the data. In some implementations, data can include one or more of structured data, unstructured data, vectorized data, etc., or types of digital files, including text data, audio data, image data, video data, multimedia, interactive media, data objects, and/or any suitable type of digital resource, among other types of data. An example of data stored at the data store 106 can include a file, database record, database entry, programming code or document, among others. The data store 106 can bc hosted by one or more storage devices, such as main memory, magnetic or optical storage based disks, tapes or hard drives, network-attached storage (NAS), storage area network (SAN), and SO forth. In some implementations, the data store 106 can be a network-attached file server, while in other implementations the data store 106 can be another type of persistent storage such as an object-oriented database, a relational database, and so forth, that can be hosted by virtual meeting platform 120, or one or more different machines coupled to the server hosting the virtual meeting platform 120 via the network 108.

Virtual meeting platform 120 can enable users of client devices 102A-102N and/or client device(s) 104 to connect with each other via a virtual meeting 121 (e.g., a virtual meeting 121). A virtual meeting 121 refers to a real-time communication session such as a virtual meeting 121 call, also known as a video-based call or video chat, in which participants can connect with multiple additional participants in real-time and be provided with audio and/or video capabilities. Real-time communication refers to the ability for participants to communicate (e.g., exchange information) instantly without transmission delays and/or with negligible (e.g., milliseconds or microseconds) latency. Virtual meeting platform 120 can allow a user (e.g., a participant of the virtual meeting 121) to join and participate in a virtual meeting 121 with other users of the platform (e.g., other participants of the virtual meeting 121). Implementations of the present disclosure can be implemented with any number of participants connecting via the virtual meeting 121.

The virtual meeting platform 120 can include a translation engine 150. In some implementations, at least a portion of the translation engine 150 may be included in client devices 102A-102N, servers 130, 140, or other elements of the system 100. The translation engine 150 can include an audio data context engine 151 and a translator 156 to handle media streams 152 and translated audio portions 155. In some implementations, the translation engine 150 does not include the translator 156, but rather accesses the translator 156, which may be hosted by another element of the system 100.

During a virtual meeting, the translation engine 150 receives a media stream 152. A "media stream" can refer to a real-time communication of a continuous sequence of encoded data packets representing audio, video, or other media content transmitted over a network. In some implementations, the media stream 152 may be encapsulated using the Real-time Transport Protocol (RTP), with associated control signaling provided by the Real-time Control Protocol (RTCP) to support synchronization, packet loss recovery, and quality monitoring. Stream parameters, including codec selection, bitrate, and resolution, may be dynamically adapted in response to fluctuating network conditions to maintain low latency and consistent media quality, such as by the connection manager 165 of the virtual meeting manager 122, described below.

The media stream 152 can include media stream portions 153. In some implementations, each media stream portion 153 corresponds to a duration of a portion of the media stream 152 (e.g., a time interval). For example, the media stream portions 153 may represent 5-second intervals of the media stream 152. That is, each media stream portion 153 may include media data for sequential 5-second time intervals of the media stream 152. In some implementations, each media stream portion 153 includes a predetermined number of data packet(s) of the continuous sequence of encoded data packets. In alternative implementations, each media stream portion 153 includes a variable number of data packet(s) of the continuous sequence of encoded data packets. In some implementations, the variable number of data packet(s) may be determined by the audio data context engine 151. In some implementations, a size of the media stream portion 153 is based on data in the media stream 152, such as audio data (represented as original audio portion(s) 154). In some implementations, a size or duration of the original audio portion 154 may be selected based on one or more of: speech content in the audio portion(s) 154, a duration or time interval, a quantity of data (such as a number of data packets in the continuous sequence of encoded data packets), or the like. In some implementations, the audio data context engine 151 can select a size or duration of the original audio portion 154. For example, the audio data context engine 151 can determine a size or duration of the original audio portion 154 to correspond to a detected word, phrase or sentence, or speaking duration.

In some implementations, the translation engine 150 receives media stream portion 153 at different time points and separates original audio portions 154 from corresponding media stream portions 153. In some implementations, the audio data context engine 151 of the translation engine 150 is responsible for separating original audio portions 154 from the corresponding media stream portions 153. In some implementations, the original audio portions 154 are extracted from the media stream portions 153 based on a size or duration of the original audio portion, as determined by the audio data context engine 151.

The translation engine 150 can provide original audio portions 154 to the translator 156. The translator 156 can generate translated audio portions 155 from the original audio portions 154. In some implementations, the translator 156 includes and/or interfaces with an artificial intelligence (AI) model, such as AI model 141, that uses original audio portions 154 as input and generates translated audio portions 155 as outputs. In some implementations, the translator 156 is configured to receive an audio input in an original language and generate an audio output in a translated language (e.g., target language). In some implementations, the translator 156 is configured to generate translated audio data (e.g., speech data in a translated language) directly from original audio data (e.g., speech data in an original language) without any speech-to-text based intermediary steps. In some implementations, the translator 156 is configured to translate multiple original languages into multiple translated languages. For example, the translator 156 can be configured to translate speech in English into speech in Spanish, speech in Russian into speech in French, etc. In some implementations, multiple translation engines 156 are configured for each language pairing. For example, a first translator 156 can be used to translate speech in English into speech in Spanish (and vice versa), and a second translator 156 can be used to translate speech in Russian into speech in French (and vice versa). In some implementations, an AI model 141 can be trained to perform one or more functions of the translator 156 described herein.

The translation engine 150 can provide the translated audio portions 155 to a respective client device 102A-102N, 104 that is receiving the media stream 152 from the virtual meeting platform. In some implementations, the translated audio portions 155 are provided based on one or more parameters of the virtual meeting 121, and/or user preferences associated with participants using one or more of the client device 102A-102N, 104.

During a virtual meeting 121, the translation engine 150 may receive media stream portions 153 from one or more client devices 102A-102N, 104 sequentially at different times. In some implementations, the media stream portions 153 are received as a media stream 152. Each media stream portion 153 may include an original audio portion 154. The translation engine 150 may extract an original audio portion 154 from a media stream portion 153. The audio portion 154 may include speech data. In some implementations, speech data in audio stream portion 154 may be in a first language (e.g., an original language).

In some implementations, the audio data context engine 151 may determine whether one or more original audio portion(s) 154 satisfy one or more translation sufficiency criteria. In some implementations, the translation sufficiency criteria may include one or more of: an input criterion, a processing duration criterion, a delay criterion, a context criterion, or the like.

In some implementations, the input criterion can refer to a maximum input that can be provided to the translation engine, such as a maximum duration of audio data, a maximum size of the audio data, etc.

In some implementations, the processing duration criterion can refer to the amount of time for the translator 156 to generate an output (e.g., a translated audio portion 155) from a received input (c.g., an original audio portion 154).

In some implementations, the delay criterion can refer to a maximum delay between when an original audio portion is provided to a client device 102A-102N, 104 and when a translated audio portion 155 is provided to the same client device. The delay criterion can be based on the input criterion (e.g., a maximum duration) and the processing duration criterion. In some implementations, the delay criterion represents a sum of a duration of a duration criterion (e.g., an input criterion) and a duration the processing duration criterion.

In some implementations, the context criterion can refer to a minimum number of words, phrases or the like that are detected in speech data that is included in one or more of the original audio portions 154. In some implementations, the context criterion can be based on a detection of one or more translation units in speech data from one or more original audio portions 154. As used herein, a "translation unit" can refer to a segment of speech that is treated as a single unit for the purposes of establishing an equivalent translation in another language. A translation unit may be one or more words, phrases, sentences, or the like. In some implementations, a translation unit may include a figure of speech, such as an idiom. For example, if the audio data context engine 151 detects a portion of a figure of speech in an original audio portion 154, then the original audio portion 154 is determined to satisfy the context criterion if it contains the full figure of speech.

When the audio data context engine 151 determines that one or more original audio portions 154 satisfy the translation sufficiency criteria, the audio data context engine 151 can provide the one or more original audio portions 154 that satisfy the translation sufficiency criteria as input to the translator 156. In some implementations, if the audio data context engine 151 determines that the one or more original audio portions 154 do not satisfy the translation sufficiency criteria, then the audio data context engine 151 waits for an additional original audio portion 154. When the additional original audio portion 154 is received, the audio data context engine 151 aggregates it with the one or more original audio portions 154 and reevaluates the resulting aggregated portions against the translation sufficiency criteria.

For example, if an original audio portion 154 (e.g., first audio portion) does not satisfy the translation sufficiency criteria, it may be combined with a next audio portion 154 (e.g., second audio portion). The audio data context engine 151 can determine whether the combination of audio portions 154 (c.g., the combination of the first and second audio portions) satisfics the translation sufficiency criteria. If the combination of the audio portion 154 still does not satisfy the translation sufficiency criteria, it may be combined with a subsequent audio portion 154 (e.g., third audio portion). The audio data context engine 151 can determine whether the combination of audio portions 154 (e.g., the combination of the first, second, and third audio portions) satisfies the translation sufficiency criteria. This process may be repeated as necessary until a combination of audio portions 154 (e.g., combination of original audio portions 154) satisfics the translation sufficiency criteria, described herein.

In some implementations, the translation sufficiency criteria can be based on the translated language pairs. For example, when translating between the language pair of Spanish and Portuguese, one or more of the translation sufficiency criteria may be different than when translating between the language pair of English and Russian. This is because Spanish and Portuguese as languages may have more similarities and/or overlap in words, structure, and cultural aspects than English and Russian. These similarities/overlap between languages can reduce the amount of data (e.g., audio data) that is used to effectively translate between the two languages. Thus, in the illustrative example, an input duration criterion for a Spanish-to-Portugues translation may be shorter than an input duration criterion for an English-to-Russian translation.

Once translated audio portions 155 are generated by the translator 156 and obtained by the translation engine 150, the translation engine 150 can provide the translated audio portions to a respective client device(s) 102A-102N, 104 that has requested the translation. In some implementations, the audio data context engine 151 provides the translated audio portions 155 to the respective client device(s) 102A-102N, 104. In some implementations, the translation engine 150 generates a translated audio stream from the translated audio portions 155. In some implementations, the translation engine 150 provides the original audio portions 154 to each client device 102A-102N, 104 and the translated audio portions 155 to client devices 102A-102N, 104 that have selected a translation option. In some implementations, the original audio portions 154 are played in real-time (e.g., as they are received for the media stream portions 153) at a lower audio volume than the translated audio portions, which are played at a delay with respect to the media stream portions 153.

In some implementations, the translated audio portions 155 include or are in the form of synthesized specch. The speech can be synthetically generated based on prosodic speech elements (e.g., prosodic elements) of a particular speaker. In some implementations, prosodic elements include one or more of volume, intonation, articulation, speed, pronunciation, prosodic speech patterns, style, cadence, emphasis or the like of a speaker. In some implementations, the speech in translated audio portions 155 is synthetically generated to resemble the tone of voice of the original speaker. In some implementations, the speech in translated audio portions 155 is synthetically generated to resemble a tone of voice that is selected by one or more users of client devices 102A- 102N, 104 that are receiving translated audio portions 155. In some implementations, the speech in translated audio portions 155 is synthetically generated (e.g., as synthesized speech) to resemble a tone of voice that is selected by a speaker that is providing the original audio portions 154 to the translation engine 150 (e.g., through a respective client device 102A-102N, 104).

Depending on the time needed to obtain context, process translation, account for a difference in the length of words, or the like, the delay between the original audio portions 154 and the translated audio portions can change dynamically. In some implementations, the translation processing operations account for such varying delays by inserting one or more delays into or between translated audio portion(s) 155, altering a duration of translated audio portion(s) 155, generating equivalent longer translations of the translated audio portion(s) 155, adjusting a speaking speed in the translated audio portion(s) 155, adjusting an intonation in the translated audio portion(s) 155, adjusting an articulation in the translated audio portion(s) 155, adjusting a pronunciation in the translated audio portion(s) 155, or the like. In an illustrative example, a first input to the translator 156 may include a single original audio portion 154, and the translator 156 can generate a corresponding translated audio portion 155 after a short processing delay. A second input to the translator 156 may include five original audio portions 154, which if not addressed, may cause an undesirable pause in the translated audio stream due to the dynamic adjustment of the size and/or duration of inputs provided to the translator 156. Thus, to reduce or remove these types of gaps between translated audio portions 155, the translation engine 150 can perform one or more of the above-mentioned processing operations on the translated audio portions 155 to reduce or mitigate the occurrence or duration of such pauses.

In some implementations, a user that is speaking (e.g., a virtual meeting participant) can receive an indication in their respective user interface (UI), (e.g., UI 124A-124N) that provides the speaker with one or more options for a generated translation of their specch. For example, the speaking participant may receive an indication of a first translation of their speech into a translated language, and a second translation of their speech into a translated language, and be prompted to select either the first translation or the second translation. This feature may be useful, for example, to speakers who speak in the original language, but understand the translated language, as it may increase their control over what the virtual meeting participants hear in the translated audio portions 155. In some implementations, this feature is enabled when there is a relatively long delay in the translation (e.g., approximately 2-3 seconds more more). In some implementations, this feature may be disabled when there is a relatively short delay in the translation [e.g., < 10 seconds].

Thus, the participants of the virtual meeting 121 can receive translated audio portions 155 at their respective client devices 102A-102N, 104. The client devices 102A-102N can each include computing devices such as a desktop personal computer (PCs), laptop computer, mobile phone, tablet computer, netbook computer, wearable device (e.g., smart watch, smart glasses, etc.) network-connected television, smart appliance (e.g., video doorbell), any type of mobile device, etc. In some implementations, client devices 102A-102N can be one or more computing devices (such as a rackmount server, a router computer, a server computer, a personal computer, a mainframe computer, a laptop computer, a tablet computer, a desktop computer, etc.), data stores (e.g., hard disks, memories, databases), networks, software components, or hardware components. In some implementations, client devices 102A-102N can also be referred to as "user devices." Each client device 102A-102N can include an audiovisual component that can generate audio and video data to be streamed to virtual meeting platform 120. In some implementations, the audiovisual component can include a device (e.g., a microphone) to capture an audio signal representing speech of a user and generate audio data (e.g., an audio file or audio stream) based on the captured audio signal. The audiovisual component can include another device (e.g., a speaker) to output audio data to a user (e.g., a participant of the virtual meeting 121) associated with a particular client device. In some implementations, the audiovisual component can also include an image capture device (e.g., a camera) to capture images and generate video data (e.g., a media stream 152) of the captured data of the captured images.

In some implementations, the client devices 102A-102N can implement or include one or more applications to communicate (e.g., send and receive information) with the virtual meeting platform 120. In some implementations, the client devices 102A-102N can implement a user interface (UI) (e.g., graphical user interfaces (GUIs)), such as a UI 124A-124N) that may be webpages rendered by a web browser and displayed on the client devices 102A-102N in a web browser window. In another embodiment, the UI 124A-124N of the client devices 102A-102N may be included in a stand-alone application downloaded to the client devices 102A-102N and natively running on the client devices 102A-102N (also referred to as a "native application" or "native client application" herein). In some implementations, some or all portions of the private audio engine 151 can be implemented at the client device 102A-102N.

In some implementations, the virtual meeting platform 120 is coupled, via network 108, with one or more client device(s) 104 that are each associated with a physical conference or meeting room. Client device(s) 104 can include or be coupled to a media system 110 that can include one or more display devices 111, one or more speaker(s) 112 and one or more camera(s) 113. Display device 111 can be, for example, a smart display or a non-smart display (e.g., a display that is not itself configured to connect to network 108). Users that are physically present in the room can use the media system 110 rather than their own devices (e.g., client devices 102A-102N) to participate in virtual meeting 121, which can include other remote users. For example, the users in the room that participate in the virtual meeting 121 can control the display device 111 to show a slide presentation or watch slide presentations of other participants. Sound and/or camera control can similarly be performed. Similar to client devices 102A-102N, client device(s) 104 can generate audio and video data to be streamed to virtual meeting platform 120 (c.g., using one or more microphones, speaker(s) 112 and camera(s) 113).

Each client device 102A-102N or client device(s) 104 can include a browser and/or a client application (e.g., a mobile application, a desktop application, etc.). In some implementations, the web browser and/or the client application can present, on a display device 103A-103N of client device 102A-102N, a user interface (UI) (e.g., a UI of the UIs 124A-124N) for users to access the virtual meeting platform 120. For example, a user of client device 102A can join and participate in a virtual meeting 121 via a UI 124A presented on the display device 103A by the web browser or client application. A user can also present a document to participants of the virtual meeting 121 via each of the UIs 124A-124N. Each of the UIs 124A-124N can include multiple regions to present media streams 152 corresponding to media streams 152 of the client devices 102A-102N provided to the server 130 for the virtual meeting 121. In some implementations, the UIs 124A- BN may include various visual elements (e.g., UI elements) and regions, and can be a mechanism by which the user engages with the virtual meeting platform 120, and system 100 at large. In some implementations, the UIs 124A-124N of the client devices 102A-102N can include multiple visual elements and regions that enable presentation of information, for decision-making, content delivery, etc. at the client devices 102A-102N. In some implementations, the UIs 124A-124N may sometimes be referred to as a graphical user interface (GUI)).

In some implementations, the UIs 124A-124N and/or client devices 102A-102N can include input features to intake information from a client devices 102A-102N. In one or more examples, a user of client devices 102A-102N can provide input data (e.g., a user query, control commands, etc.) into an input feature of the UIs 124A-124N or client devices 102A-102N, for transmission to the virtual meeting platform 120, and system 100 at large. Input features of UIs 124A-124N and/or client devices 102A-102N can include space, regions, or elements of the UIs 124A-124N that accept user inputs. For example, input features may include visual elements (e.g., GUI elements) such as buttons, text-entry spaces, selection lists, drop-down lists, etc. For example, in some implementations, input features may include a chat box which a user of client devices 102A-102N can use to input textual data (e.g., a user query). The client devices 102A-102N can then transmit that textual data to virtual meeting platform 120, and the system 100 at large, for further processing. In other examples, input features can include a selection list, in which a user of client devices 102A-102N can input selection data e.g., by selecting, or clicking. The client devices 102A-102N can then transmit that selection data to virtual meeting platform 120, and the system 100 at large, for further processing.

In some implementations, server 130 can include a virtual meeting manager 122. Virtual meeting manager 122 is configured to manage a virtual meeting 121 between multiple users of virtual meeting platform 120. In some implementations, the virtual meeting manager 122 can provide the UIs 124A-124N to each client device to enable users to watch and listen to each other during a virtual meeting 121. Virtual meeting manager 122 can also collect and provide data associated with the virtual meeting 121 to each participant of virtual meeting 121. In some implementations, virtual meeting manager 122 can provide the UIs 124A-124N for presentation by a client application (e.g., a mobile application, a desktop application, etc.). For example, the UIs 124A-124N can be displayed on a display device 103A-103N by a native application executing on the operating system of the client device 120A-120N or the client device(s) 104. The native application can be separate from a web browser. In some implementations, the virtual meeting manager 122 can determine visual items for presentation in the UI 124A-124N during a virtual meeting 121. A visual item can refer to a UI element that occupies a particular region in the UI and is dedicated to presenting a media stream 152 from a respective client device. Such a media stream 152 can depict, for example, a user of the respective client device while the uscr is participating in the virtual meeting 121 (e.g., speaking, presenting, listening to other participants, watching other participants, etc., at particular moments during the virtual meeting 121), a physical conference or meeting room (e.g., with one or more participants present), a document or other media content (e.g., video content, one or more images, etc.) being presented during the virtual meeting 121, and the like. It is appreciated that providing media streams 152 for presentation is described herein by way of example, and not limitations, noting that aspects and implementations of the present disclosure can be applied to other visual items (e.g., recorded videos) without deviating from the scope of the present disclosure.

In some implementations, the virtual meeting manager 122 includes a media stream 152 processor 163, a user interface (UI) manager 164, and a connection manager 165. The components can be combined together or separated into further components, according to a particular implementation. It should be noted that in some implementations, various components of the virtual meeting manager 122 can run on separate machines.

The media stream 152 processor 163 can receive media streams 152 from client devices 102A-102N and/or client device(s) 104. The media stream 152 processor 163 can determine media streams 152 for presentation in the UIs 124A-124N during the virtual meeting 121. Each media stream 152 152 can correspond to a media stream 152 152 from a client device (e.g., the media stream 152 pertaining to one or more participants of the virtual meeting 121). In some implementations, the media stream 152 processor 163 can receive audio streams associated with the media streams 152 from the client devices (e.g., from an audiovisual component of the client devices 102A-102N).

The User Interface (UI) manager 164 can provide a UI for a virtual meeting 121. The UI can include multiple regions. Each region can display a media stream 152 pertaining to one or more participants of the virtual meeting 121. The UI manager 164 can control which media stream 152 is to be displayed by providing a command to the client devices that indicates which media stream 152 is to be displayed in which region of the UI (along with the received video and audio streams being provided to the client devices). For example, in response to being notified of the determined media streams 152 for presentation in the UI 124A-124N, the UI manager 164 can transmit a command causing each determined media stream 152 to be displayed in a region of the UI and/or rearranged in the UI.

The connection manager 165 can manage connections of the client devices 102A-102N to the virtual meeting 121 of the virtual meeting platform 120. In some implementations, the connection manager 165 enables a client device 102A-102N to establish a network connection to the virtual meeting platform 120. In some implementations, the connection manager 165 can monitor a connection health between a client device 102A-102N and the virtual meeting platform 120. Connection health may depend on one or more of connection latency, packet loss, packet jitter, or the like. In some implementations, the connection manager 165 can adjust connection parameters, such as a bitrate, resolution, or the like in response to a monitored connection health. For example, if the connection health is poor (e.g., there are a large number of dropped packets, high latency, etc.), the connection manager B may reduce a bitrate, resolution, or the like of media streams 152 transmitted to the device 102A-102N. In another example, if the connection health is satisfactory, (e.g., there are a minimal number of dropped packets, low latency, etc.), the connection manager 165 may increase a bitrate, resolution, or the like of media streams 152 transmitted to the device 102A-102N. In some implementations, the connection manager 165 may attempt to reestablish a connection with a device 102A-102N in the event of an unintended disconnection. In some implementations, the connection manager 165 may attempt to route the delivery of the media stream 152 to the device 102A-102N through alternative network paths based on the determined connection health.

A participant can join and participate in a virtual meeting 121 via a UI 124A presented on the display device 103A by the web browser or client application. As described previously, an audiovisual component of each client device can capture images and generate video data (e.g., a media stream 152) of the captured data of the captured images. In some implementations, the client devices 102A-102N and/or client device(s) 104 can transmit the generated media stream 152 to virtual meeting manager 122. The audiovisual component of each client device can also capture an audio signal representing speech of a user and generate audio data (e.g., an audio file or audio stream) based on the captured audio signal. In some implementations, the client devices 102A- 102N and/or client device(s) 104 can transmit the generated audio data to virtual meeting manager 122.

In some implementations, a client device 102A can access the virtual meeting platform 120 through network 108 using one or more application programming interface (API) calls via platform API endpoint 129. In some implementations, virtual meeting platform 120 can include multiple platform API endpoints 129 that can expose services, functionality, or information of the virtual meeting platform 120 to one or more client devices 102A-102N. In some implementations, a platform API endpoint 129 can be one end of a communication channel, where the other end can be another system, such as a client device 102A associated with a participant or user account. In some implementations, the platform API endpoint 129 can include or be accessed using a resource locator, such a universal resource identifier (URI), universal resource locator (URL), of a server or service. The platform API endpoint 129 can receive requests from other systems, and in some cases, return a response with information responsive to the request. In some implementations, HTTP (Hypertext Transfer Protocol), HTTPS (Hypertext Transfer Protocol Secure) methods (e.g., API calls) can be used to communicate to and from the platform API endpoint 129.

In some implementations, the platform API endpoint 129 can function as a computer interface through which access requests are received and/or created. In some implementations, the platform API endpoint 129 can include a platform API whereby external entities or systems can request access to services and/or information provided by the virtual meeting platform 120. The platform API can be used to programmatically obtain services and/or information associated with a request for services and/or information.

In some implementations, the API of the platform API endpoint 129 can be any suitable type of API such as a REST (Representational State Transfer) API, a GraphQL API, a SOAP (Simple Object Access Protocol) API, and/or any suitable type of API. In some implementations, the virtual meeting platform 120 can expose through the API, a set of API resources which when addressed can be used for requesting different actions, inspecting state or data, and/or otherwise interacting with the virtual meeting platform 120. In some implementations, a REST API and/or another type of API can work according to an application layer request and response model. An application layer request and response model can use HTTP, HTTPS, SPDY, or any suitable application layer protocol. Herein HTTP-based protocol is described for purposes of illustration, rather than limitation. The disclosure should not be interpreted as being limited to the HTTP protocol. HTTP requests (or any suitable request communication) to the virtual meeting platform 120 can observe the principals of a RESTful design or the protocol of the type of API. RESTful is understood in this document to describe a Representational State Transfer architecture. The RESTful HTTP requests can be stateless, thus each message communicated contains all necessary information for processing the request and generating a response. The platform API can include various resources, which act as endpoints that can specify requested information or requesting particular actions. The resources can be expressed as URI's or resource paths. The RESTful API resources can additionally be responsive to different types of HTTP methods such as GET, PUT, POST and/or DELETE.

It can be appreciated that in some implementations, any element, such as server 130, and/or data store 106 may include a corresponding API endpoint for communicating with APIs.

In some implementations, virtual meeting platform 120 and/or server 130 can be one or more computing devices (such as a rackmount server, a router computer, a server computer, a personal computer, a mainframe computer, a laptop computer, a tablet computer, a desktop computer, etc.), data stores (c.g., hard disks, memories, databases), networks, software components, and/or hardware components that may be used to enable a user to connect with other users via a virtual meeting 121. Virtual meeting platform 120 can also include a website (e.g., a webpage) or application back-end software that may be used to enable a user to connect with other users via virtual meeting 121.

The system 100 can include an artificial intelligence (AI) model, e.g., AI model 141. In some implementations, the AI model 141 is an artificial intelligence (AI) model (e.g., also referred to as an "machine learning (ML) model" herein). An AI model can include a discriminative machine learning model (also referred to as "discriminative AI model" herein), or a generative machine learning model (also referred to as "generative AI model" herein).

In some implementations, a discriminative AI model can model a conditional probability of an output for given input(s). A discriminative AI model can learn the boundaries between different classes of data to make predictions on new data. In some implementations, a discriminative AI model can include a classification model that is designed for classification tasks, such as learning decision boundaries between different classes of data and classifying input data into a particular classification. Examples of discriminative AI models may include support vector machines (SVM) and neural networks.

In some implementations, a generative AI model learns how the input training data is generated and can generate new data (e.g., original data). A generative AI model can model the probability distribution (e.g., joint probability distribution) of a dataset and generate new samples that often resemble the training data. Generative AI models can be used for tasks involving image generation, text generation and/or data syn-thesis. Generative AI models may include gaussian mixture models (GMMs), variational autoencoders (VAEs), generative adversarial networks (GANs), large language models (LLMs), vision-language models (VLMs), multi-modal models (e.g., text, images, video, audio, depth, physiological signals, etc.), and SO forth.

In some implementations, the Al model 141 may be trained to translate media in a first language into media in a second language. For example, the AI model 141 may be trained to translate text data in a first language into text data in a second language. In another example, the AI model 141 may be trained to translate audio or speech data in a first language into audio or speech data in a second language. The AI model 141 can bc a model that is trained on data generated by a training set generator. The training set generator may be capable of generating training data (e.g., a set of training inputs and a set of target outputs) to train the Al model 141. In some implementations, the training set generator can generate the training data based on various data (e.g., stored at data store 106 or another data store connected to system 100 via the network 108). The data store 106 can store metadata associated with the training data

In some implementations, the AI model 141 is trained on training sets by a training engine. The AI model 141 (also referred to "machine learning model" or "artificial intelligence (AI) model" herein) may refer to the model artifact that is created by the training engine using the training data that includes training inputs (e.g., features) and corresponding target outputs (correct answers for respective training inputs) (e.g., labels). The training engine may find patterns in the training data that map the training input to the target output (the answer to be predicted) and provide the AI model 141 that captures these patterns. The AI model 141 may be composed of, e.g., a single level of linear or non-linear operations (e.g., a support vector machine (SVM), or may be a deep network, i.e., a machine learning model that is composed of multiple levels of non-linear operations). An example of a deep network is a neural network with one or more hidden layers, and such a machine learning model may be trained by, for example, adjusting weights of a neural network in accordance with a backpropagation learning algorithm or the like. AI model 141 can use one or more of a support vector machine (SVM), Radial Basis Function (RBF), clustering, supervised machine learning, semi-supervised machine learning, unsupervised machine learning, k-nearest neighbor algorithm (k-NN), linear regression, random forest, neural network (e.g., artificial neural network), a boosted decision forest, etc. For convenience rather than limitation, the remainder of this disclosure describing a discriminative machine learning model will refer to the implementation as a neural network, even though some implementations might employ other types of learning machine instead of, or in addition to, a neural network.

In some implementations, such as with a supervised machine learning model, the one or more training inputs of the set of the training inputs are paired with respective one or more training outputs of the set of training outputs. The training input-output pair(s) can be used as input to the machine learning model to help train the machine learning model to determine, for example, patterns in the data.

In some implementations, the AI model 141 can be a generative AI model. A generative AI model is an AI model which can generate new, original data. An AI model 141 can include a generative adversarial network (GAN) and/or a variational autoencoder (VAE). In some instances, a GAN, a VAE, and/or other types of generative AI models can employ different approaches to training and/or learning the underlying probability distributions of training data, compared to some AI models.

For instance, a GAN can include a generator network and a discriminator network. The generator network attempts to produce synthetic data samples that are indistinguishable from real data, while the discriminator network seeks to correctly classify between real and fake samples. Through this iterative adversarial process, the generator network can gradually improve its ability to generate increasingly realistic and diverse data.

In some implementations, the AI model 141 can be a generative large language model (LLM). In some implementations, the AI model 141 can be a large language model that has been pre-trained on a large corpus of data SO as to process, analyze, and generate human-like text based on given input.

In some implementations, the AI model 141 may have any architecture for LLMs, including one or more architectures as seen in Generative Pre-trained Transformer (GPT) series (Chat GPT series LLMs), Google's Gemini®, or LaMDA, or leverage a combination of transformer architecture with pre-trained data to create coherent and contextually relevant text.

In some implementations, an AI model 141, such as an LLM, can use an encoder-decoder architecture including one or more self-attention mechanisms, and one or more feed-forward mechanisms. In some implementations, the AI model 141 can include an encoder that can encode input textual data into a vector space representation; and a decoder that can reconstruct the data from the vector space, generating outputs with increased novelty and uniqueness. The self- attention mechanism can compute the importance of phrases or words within a text data with respect to all of the text data. An AI model 141 can also utilize the previously discussed deep learning techniques, including recurrent neural networks (RNNs), convolutional neural networks (CNNs), or transformer networks.

In some implementations, the AI model 141 can be a multi-modal generative AI model, such as a Visual-Language Model (VLM). In some implementations, the AI model 141 can be a VLM that has been pre-trained on a large corpus of data (c.g., textual data and image data) so as to process, analyze, and generate human-like text and/or image data based on given input (e.g., image data and/or natural language text).

In some implementations, training a generative Al model can include providing training input to an AI model 141, and the AI model 141 can produce one or more training outputs. The one or more training inputs can be compared to one or more evaluation metrics. An evaluation metric can refer to a measure used to assess the output (e.g., training output(s)) of an AI model, such as an AI model 141. In some implementations, the evaluation metric can be specific to the task and/or goals of the AI model. Based on the comparison, one or more parameters and/or weights of the AI model 141 can be adjusted (e.g., backpropagation based on computed loss). In some implementations, and for example, the one or more training outputs can be compared to an evaluation metric such as a ground truth (e.g., target output, such as a correct or better answer). In some implementations and for example, the one or more training outputs can be evaluated/compared to an evaluation metric and can be rewarded (e.g., evaluated as a positive answer) or penalized (e.g., evaluated as a negative answer) based on the quality of the one or more training outputs (e.g., reinforcement learning).

In some implementations, a validation engine may be capable of validating an AI model 141 using a corresponding set of features of a validation set from the training set generator. In some implementations, the validation engine may determine an accuracy of each of the trained generative models, such as AI model 141 (e.g., accuracy of the training output) based on the corresponding sets of features of the validation set. The validation engine may discard a trained AI model 141 that has an accuracy that does not meet a threshold accuracy. In some implementations, a selection engine not shown) may be capable of selecting an AI model 141 that has an accuracy that meets a threshold accuracy. In some implementations, the selection engine may be capable of selecting the trained AI model 141 that has the highest accuracy of the trained generative models (e.g., Al model 141).

A testing engine may be capable of testing a trained AI model 141 using a corresponding set of features of a testing set from the training engine. For example, a first trained AI model 141 that was trained using a first set of features of the training set may be tested using the first set of features of the testing set. The testing engine may determine a trained AI model 141 that has the highest accuracy of all of the trained AI models based on the testing sets.

In some implementations, an Al model 141 can be trained on a corpus of data, such textual data and/or image data. In some implementations, the AI model 141 can be a model that is first pre-trained on a corpus of text to create a foundational model (e.g., also referred to as "pre- trained model" herein), and afterwards adapted (e.g., fine-tuned or transfer learning) on more data pertaining to a particular set of tasks to create a more task-specific or targeted generative AI model (e.g., also referred as an "adapted model" herein.) The foundational model can first be pre-trained using a corpus of data (e.g., text and/or images) that can include text and/or image content in the public domain, licensed content, and/or proprietary content (e.g., proprietary organizational data). The AI model 141 can use pre-training to learn broad image elements and/or broad language elements including general sentence structure, common phrases, vocabulary, natural language structure, and any other elements commonly associated with natural language in a large corpus of text. In example, the pre-trained model can be fine-tuned to the specific task or domain that the Al model 141 is to be adapted. In some implementations, AI model 141 may include one or more pre- trained models or adapted models.

In some implementations, training data, such as training input and/or training output, and/or input data to a trained machine learning model (collectively referred to as "machine learning model data" herein) can be preprocessed before providing the aforementioned data to the (trained or untrained) machine learning model (e.g., discriminative machine learning model and/or generative machine learning model) for execution. Preprocessing as applied to machine learning models (e.g., discriminative machine learning model and/or generative machine learning model) can refer to the preparation and/or transformation of machine learning model data.

In some implementations, preprocessing can include data scaling. Data scaling can include a process of transforming numerical features in raw machine learning model data such that the preprocessed machine learning model data has a similar scale or range. For example, Min-Max scaling (Normalization) and/or Z-score normalization (Standardization) can be used to scale the raw machine learning model. For instance, if the raw machine learning model data includes a feature representing temperatures in Fahrenheit, the raw machine learning model data can be scaled to a range of [0, 1] using Min-Max scaling.

In some implementations, preprocessing can include data encoding. Encoding data can include a process of converting categorical or text data into a numerical format on which a machine learning model can efficiently execute. Categorical data (e.g., qualitative data) can refer to a type of data that represents categories and can be used to group items or observations into distinct, non- numeric classes or levels. Categorical data can describe qualities or characteristics that can be divided into distinct categories, but often does not have a natural numerical meaning. For example, colors such as red, green, and blue can be considered categorical data (e.g., nominal categorical data with no inherent ranking). In another example, "small," "medium," and "large" can be considered categorical data (ordinal categorical data with an inherent ranking or order). An example of encoding can include encoding a size feature with categories ["small," "medium," "large"] by assigning 0 to "small," 1 to "medium," and 2 to "large."

In some implementations, preprocessing can include data embedding. Data embedding can include an operation of representing original data in a different space, often of reduced dimensionality (e.g., dimensionality reduction), while preserving relevant information and patterns of the original data (e.g., lower-dimensional representation of higher-dimensional data). The data embedding operation can transform the original data so that the embedding data retains relevant characteristics of the original data and is more amenable for analysis and processing by machine learning models. In some implementations embedding data can represent original data (c.g., word, phrase, document, or entity) as a vector in vector space, such as continuous vector space. Each element (e.g., dimension) of the vector can correspond to a feature or property of the original data (e.g., object). In some implementations, the size of the embedding vector (e.g., embedding dimension) can be adjusted during model training. In some implementations, the embedding dimension can be fixed to help facilitate analysis and processing of data by machine learning models.

In some implementations, the translation engine 150 provides an input to the AI model 141. The AI model generates an output, which is obtained by the translation engine 150. In some implementations, the server 140 includes the translation engine 150 that provides an input (e.g., media stream, audio stream, media portion, audio portion, text data, etc.) as input to the trained model (e.g., AI model 141) and runs the trained model on the input to generate one or more outputs.

In some implementations, confidence data can include or indicate a level of confidence of that a particular output (c.g., output(s)) corresponds to onc or more inputs of the machine learning model (e.g., trained machine learning model). In one example, the level of confidence is a real number between 0 and 1 inclusive, where 0 indicates no confidence that output(s) corresponds to a particular one or more inputs and 1 indicates absolute confidence that the output(s) corresponds to a particular one or more inputs. In some implementations, confidence data can be associated with inference using a machine learning model.

In some implementations, a machine learning model, such as AI model 141, may be (or may correspond to) one or more computer programs executed by processor(s) of server 140 and/or server 130. In other implementations, a machine learning model may be (or may correspond to) one or more computer programs executed across a number or combination of servers. For example, in some implementations, machine learning models may be hosted on the cloud, while in other implementations, these machine learning models may be hosted and perform operations using the hardware of a client devices 102A-102N. In some implementations, the machine learning models may be a self-hosted machine learning model, while in other implementations, machine learning models may be external machine learning models accessed by an API.

It is appreciated that in some other implementations, the functions of servers 130, 140 or virtual meeting platform 120 can be provided by a fewer number of machines. For example, in some implementations, servers 130, 140 can be integrated into a single machine, while in other implementations, servers 130, 140 can be integrated into multiple machines. In addition, in some implementations, servers 130, 140 can be integrated into virtual meeting platform 120.

In general, functions described in implementations as being performed by virtual meeting platform 120 or servers 130, 140 can also be performed by the client devices 102A-102N and/or client device(s) 104 in other implementations, if appropriate. In addition, the functionality attributed to a particular component can be performed by different or multiple components operating together. Virtual meeting platform 120 and/or servers 130, 140 may also be accessed as a service provided to other systems or devices through appropriate application programming interfaces, and thus is not limited to use in websites.

Although implementations of the disclosure are discussed in terms of virtual meeting platform 120 and users of virtual meeting platform 120 participating in a virtual meeting 121, implementations can also be generally applied to any type of telephone call or conference call between users. Implementations of the disclosure are not limited to virtual meeting platforms that provide virtual meeting tools to users.

In implementations of the disclosure, a "user" or "participant" can be represented as a single individual. However, other implementations of the disclosure encompass a "user" or "participant" being an entity controlled by a set of users and/or an automated source. For example, a set of individual users federated as a community in a social network may be considered a "user" or "participant." In another example, an automated consumer can be an automated ingestion pipeline, such as a topic channel, of the virtual meeting platform 120.

In situations in which the systems discussed here collect personal information about users, or may make use of personal information, the users can be provided with an opportunity to control whether virtual meeting platform 120 collects user information (e.g., information about a user's social network, social actions or activities, profession, a user's preferences, or a user's current location), or to control whether and/or how to receive content from the server 130 that can be more relevant to the user. In addition, certain data can be treated in one or more ways before it is stored or used, so that personally identifiable information is removed. For example, a user's identity may be treated so that no personally identifiable information can be determined for the user, or a user's geographic location may be generalized where location information is obtained (such as to a city, ZIP code, or state level), so that a particular location of a uscr cannot be determined. Thus, the user may have control over how information is collected about the user and used by the virtual meeting platform 120 and/or server 130.

Implementations described herein may involve the collection of data describing a user and/or activities of a user. To address the privacy of users, various techniques may be implemented. In one implementation, the collection of such data occurs only after the user provides consent. In some implementations, a user may be presented with a prompt to explicitly allow the collection of this data. In the instance where the user consents to the use of such data, the data may be used for the described functionalities.

Prior to the system enabling collection of user information (e.g., media stream 152, audio data, etc.), a user may be provided with controls allowing the user to make an election as to both if and when the system may enable such collection. For in-room participants, clear and conspicuous information regarding the data collection may be provided before their participation.

In some implementations, uscrs may be informed of the security measures in place to protect collected data, such as encryption prior to being stored. Information regarding how long the collected data may be retained and the procedures for their removal may also be provided. Users may be informed of their options regarding their biometric data. Contact information for privacy-related questions may be made available. Methods of providing such information may include in-room displays or a companion application for in-room participants, and the platform user interface for remote participants.

In some implementations, the system 100 may obtain an affirmative indication from in- room participants prior collecting user data. Participants may be informed of their ability to withdraw their consent and may be provided with mechanisms to do so, such as disabling data collection devices (c.g., cameras, microphones, etc.) or using a user interface control. The consequences of withdrawing consent may be clearly communicated.

Data describing user speech data may be treated in one or more ways before it is stored or used, so that personally identifiable information is removed. For example, a user's identity may be treated so that no personally identifiable information can be determined for the user. Access to stored user speech and/or audio data may be controlled to limit which components and personnel can access it.

The system may be designed to align with privacy considerations. Where technically viable, processing collected user data may occur locally on the client device to reduce server-side processing. Measures to reduce the risk of unintentionally capturing and processing personal and/or biometric data of individuals not participating in the meeting may be implemented. Privacy considerations may be addressed in the design of application programming interfaces (APIs), such as not retaining detailed data in logs and enforcing strong security for data retrieval. A description of the retention periods and data removal procedures for all collected and processed data related to this system may be documented.

Workspace administrators may be provided with controls to manage implementations within their domain, including the ability to enable or disable it for specific units or users and potentially remove enrollment data.

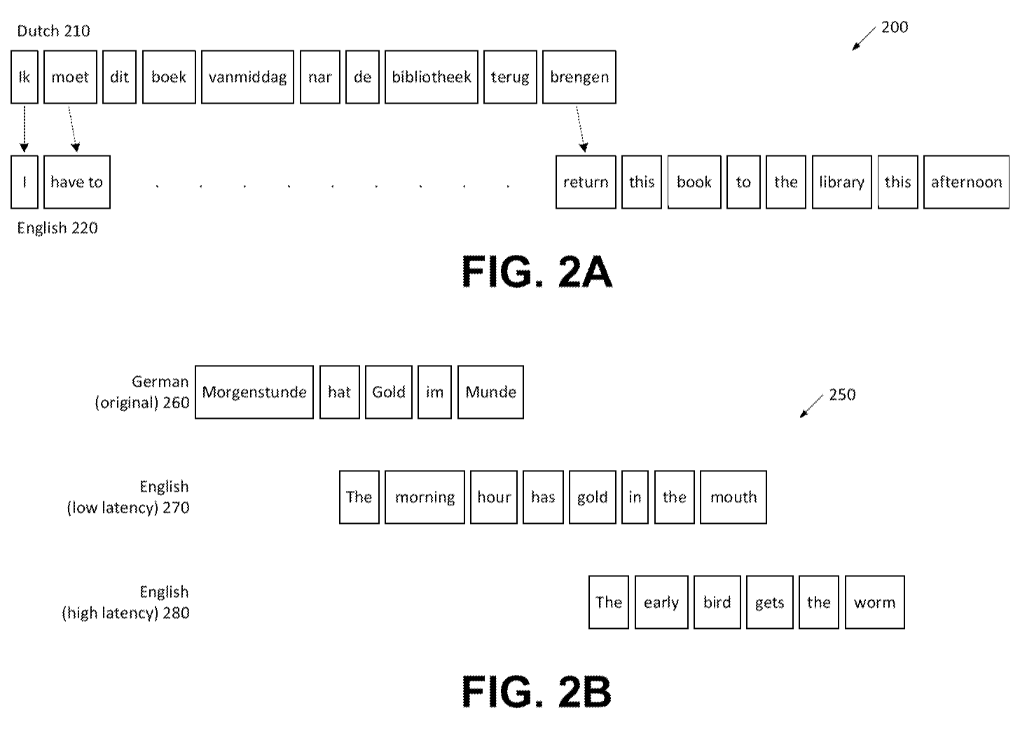

FIG. 2A is an example block diagram 200 illustrating an example of a natural delay that is present when translating between languages.

The first phrase 210 is in Dutch, "Ik moet dit boek vanmiddag nar de bibliotheek terug brengen," which can be interpreted in the second phrase 220 in English as "I have to return this book to the library this afternoon."

As illustrated, the words "ik moet" in Dutch correspond to the words "I have to" in English. However, in Dutch, the subject of the sentence "boek" comes next, while in English the verb of the sentence "return" comes next. The English translation thus may not able to be completed until the verb is spoken in Dutch, here "brengen" for "return."

This illustrates that at least while a speaker is saying the words "dit boek vanmiddag nar de bibliotheek terug brengen" the English translation cannot be determined. It is possible, depending on the translation engine and the method of providing information or inputs to the translation engine, that context is obtained from the intermediary words, but the full interpretation is delayed by the difference in sentence structure and grammar between Dutch and English.

FIG. 2B is an example block diagram 250 illustrating an example of the effects of translation latency on the quality of translation from a first language to a second language.

The first phrase 260 in German, "Morgenstunde hat Gold im Munde" is a figure of speech in German. A literal translation is represented by the second phrase 270 in English, "The morning hour has gold in the mouth." To an English speaker, this sentence likely will not make much sense, let alone convey the intended meaning of what was said in German. When a translation engine is provided with inputs without enough context, these literal translations, while they may be fast, reduce the ability of speakers to effectively communicate.

However, when enough context is obtained, the first phrase 260 in German may be detected as a figure of speech, and then translated as the third phrase 280 in English, "The early bird gets the worm." In this example, the figure of speech in German is detected and translated into an equivalent figure of speech in English. This type of translation has a longer latency, but provides a much higher quality interpretation that facilitates communication between speakers of different languages.

Implementations of the disclosure described herein reduce the latency in translation without sacrificing context that improves the quality of the translations. This is accomplished by dynamically changing the context window, or size of the "translation unit" that is provided to the translation engine, and performing post processing on the translated audio to reduce or minimize gaps between translated audio and/or translation latency.

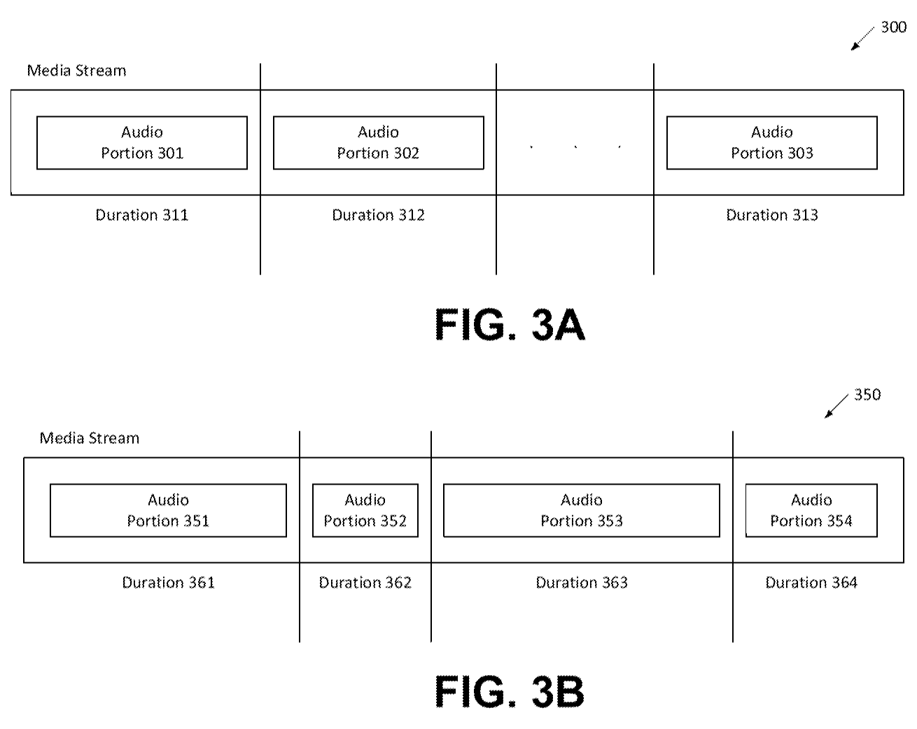

FIG. 3A is a block diagram illustrating audio portions with a predetermined size and/or duration in a media stream 300, according to some aspects of the disclosure.

The media stream 300 includes audio portion 301, audio portion 302, and audio portion 303, with corresponding duration 311, duration 312, and duration 313, respectively. In some implementations, the durations 311, 312, 313 are of the same length. In some implementations, the length of the durations 311, 312, 313 are predetermined. In some implementations, the predetermined duration may be determined by the translation engine 150 of FIG. 1 , such as by the audio context engine 151. In some implementations, the predetermined duration may be set by an organization that is hosting the virtual meeting platform 120. In some implementations, the predetermined duration may be set by one or more users who are participating in the virtual meeting 121 through the client devices 102A-102N, 104. For example, and in some implementations, a user whose speech is being translated may set the predetermined duration for audio portions of the media stream. In another example and in some implementations, a user that is receiving translated audio may set the predetermined duration for audio portions of the media stream.

In some implementations, the durations 311, 312, 313 are based on a data size of the audio portions 301, 302, 303. For example, given a certain bitrate of audio data transmission and a maximum data size for each audio portion 301, 302, 303 (as determined or set by the audio context engine 151), the durations 311, 312, 313 may have a certain size. In some implementations, the audio bitrate may change during the media stream which may cause the durations 311, 312, 313 to change as well. For example, if the audio bitrate is higher for the audio portion 301, and then lower for the audio portion 302, then the duration 311 will be shorter in comparison to the duration 312.

FIG. 3B is a block diagram illustrating audio portions with a variable size and/or duration in a media stream 350, according to some aspects of the disclosure.

The media stream 350 includes audio portion 351, audio portion 352, audio portion 353, and audio portion 354 with corresponding duration 361, duration 362, duration 363, and duration 364, respectively. In some implementations, the audio portions 351, 352, 353, 354 are determined by the audio context engine 151 of FIG. 1 based on a detected word, phrase, or the like. For example, the audio portion 351 may correspond to a first word in the media stream 350, the audio portion 352 may correspond to a second word in the media stream 350, the audio portion 353 may correspond to a third word in the media steam 350, and the audio portion 354 may correspond to a fourth word in the media steam 350. As such, each of the corresponding durations 361, 362, 363, 364 may be different in length (e.g., having lengths that correspond to the length of the detected word or phrase).

In some implementations, the dependency between words and/or phrases detected in the media stream 350 and the duration of the audio portions 351, 352, 353, 354 is determined or set by the audio context engine 151 of FIG. 1 . For example, and in some implementations, an organization hosting the virtual meeting platform 120, a user of the virtual meeting platform 120 whose speech is being translated, or a user of the virtual meeting platform 120 who is receiving a translation, may set a word level dependency. As a result, when a word is detected in the media stream 350, the audio context engine 151 can extract an audio portion 351, 352, 353, 354 that contains the detected word from the media stream 350 and initiate the translation. In another example and in some implementations, the organization or either user described above may set a phrase level dependency. Accordingly, when a phrase is detected in the media stream 350, the audio context engine 151 can extract an audio portion 351, 352, 353, 354 that contains the detected phrase from the media stream 350 and initiate the trnslation.

In some implementations, a combination of audio portions 301, 302, 303 and audio portions 351, 352, 353, 354 may be determined by the audio context engine 151 from the same media stream. For example, and in some implementations, the audio context engine 151 may extract audio portions 301, 302, 303, etc. of a fixed duration and/or size from a media stream until a certain word and/or particular phrase is detected. At which point the audio context engine 151 may extract audio portion(s) 351, 352, 353, 354, etc. that correspond to the detected certain word and/or particular phrase. After the audio portion(s) 351, 352, 353, 354 are extracted, the audio context engine 151 may continue to extract audio portions 301, 302, 303, etc. having a fixed duration and/or size from the media stream.

As will be described further herein below, in some implementations, each audio portion (e.g., audio portions 301, 302, 303, and/or audio portions 351, 352, 353, 354) is evaluated by the audio context engine 151 to determine whether it satisfies the translation sufficiency criteria. If it does not, additional audio portions (e.g., audio portions 301, 302, 303, and/or audio portions 351, 352, 353, 354) are combined and evaluated against the translation sufficiency criteria as a group by the audio context engine 151.

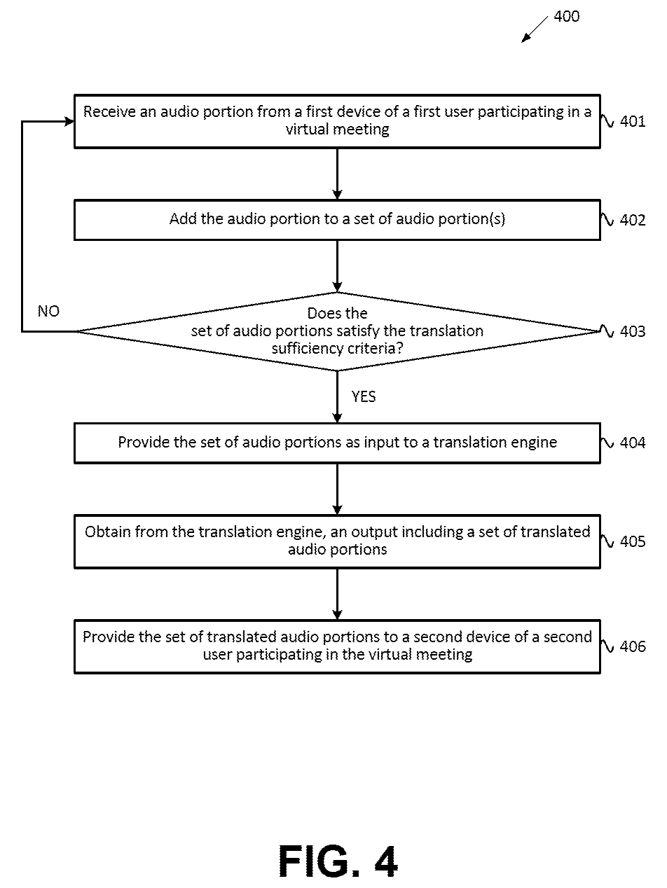

FIG. 4 is a flow diagram of an example method 400 for synthesized speech for language translation in virtual meetings, according to some aspects of the disclosure. The method 400 can be performed by processing logic that can include hardware (e.g., one or more processing devices, circuitry, dedicated logic, programmable logic, microcode, hardware of a device, integrated circuit, etc.), software (e.g., instructions run or executed on a processing device), or a combination thereof. In some implementations, the method 400 may be performed by the audio data context engine 151 of the translation engine 150 of FIG. 1 . Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 401, the processing logic performing the method 400 receives an audio portion. In some implementations, the audio portion may be received from a first device of a first user that is participating in a virtual meeting (e.g., virtual meeting 121 of FIG. 1 ).

At operation 402, the processing logic adds the audio portion to a set of audio portion(s). In some implementations, the set of audio portions is empty prior to operation 402, and thus the set only contains one audio portion after operation 402 is performed. Alternatively, the set of audio portions may already include one or more audio portions prior to operation 402, and thus the set may contain two or more audio portions after operation 402 is performed.

At operation 403, the processing logic determines whether the set of audio portions satisfies one or more translation sufficiency criteria. Responsive to determining that the set of audio portions satisfies the one or more translation sufficiency criteria, the processing logic proceeds to operation 404. Responsive to determining that the set of audio portions does not satisfy the one or more translation sufficiency criteria, the processing logic returns to the operation 401.

At operation 404, the processing logic provides the set of audio portions as input to a translation engine, such as the translator 156 of FIG. 1.

At operation 405, the processing logic obtains an output from the translation engine. The output includes a set of translated audio portions. In some implementations, each translated audio portion in the set of translated audio portions corresponds to a respective audio portion in the set of audio portions used as input to the translation engine (e.g., a 1:1 match between original audio portions and translated audio portions). In some implementations, translated audio portions may correspond to multiple original audio portions (e.g., a X:1 match between the original audio portions and the translated audio portions). In some implementations, multiple translated audio portions may correspond to a respective original audio portion (e.g., a 1:X match between the original audio portions and the translated audio portions).

At operation 406, the processing logic provides the set of translated audio portions to a device that has requested translated audio. In some implementations, the set of translated audio portions may be provided to a second device of a second user participating in the virtual meeting 121.

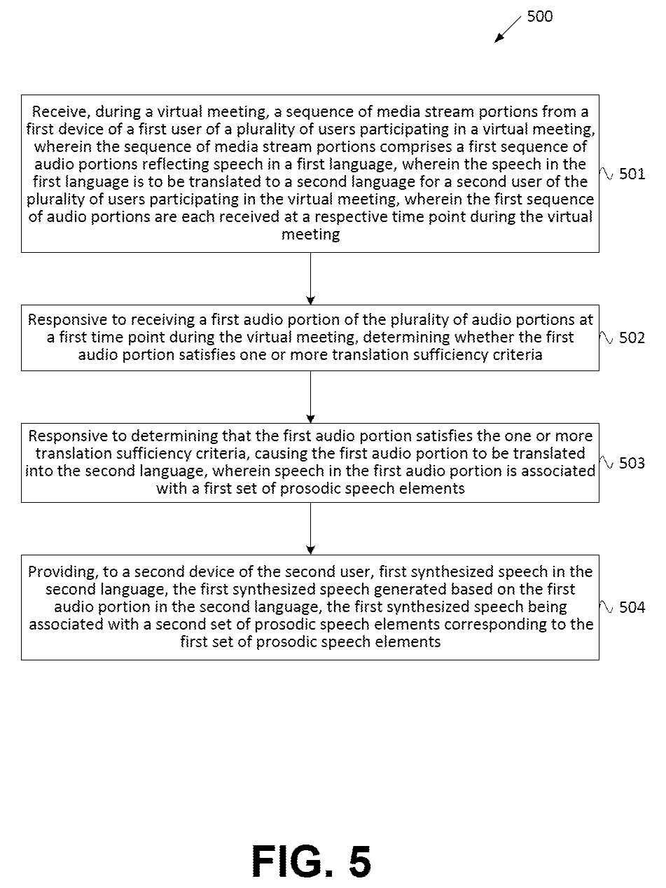

FIG. 5 is a flow diagram of an example method 500 for synthesized speech for language translation in virtual meetings, according to some aspects of the disclosure. The method 500 can be performed by processing logic that can include hardware (e.g., processing device, circuitry, dedicated logic, programmable logic, microcode, hardware of a device, integrated circuit, etc.), software (e.g., instructions run or executed on a processing device), or a combination thereof. In some implementations, the method 500 may be performed by the audio data context engine 151 of the translation engine 150 of FIG. 1. Although shown in a particular sequence or order, unless otherwise specified, the order of the processes can be modified. Thus, the illustrated implementations should be understood only as examples, and the illustrated processes can be performed in a different order, and some processes can be performed in parallel. Additionally, one or more processes can be omitted in various implementations. Thus, not all processes are required in every embodiment. Other process flows are possible.

At operation 501, the processing logic performing the method 500 receives, during a virtual meeting, a sequence of media stream portions from a first device of a first user of a participating in a virtual meeting. In some implementations, the media stream portions are received as a media stream. In some implementations, the sequence of media streams includes a sequence of audio portions reflecting speech in a first language (e.g., an original language). The speech in the first language is to be translated into a second language (e.g., a target language) for another user (e.g., a second user) participating in the virtual meeting (e.g., virtual meeting 121 of FIG. 1). In some implementations, audio portions are received at respective time points during the virtual meeting.

At operation 502, responsive to receiving a first audio portion of the plurality of audio portions at a first time point during the virtual meeting, the processing logic determines whether the first audio portion satisfies one or more translation sufficiency criteria. In some implementations, the translation sufficiency criteria include one or more of: a word criterion, an idiom criterion, an input duration criterion, a processing duration criterion, or a maximum delay criterion. In some implementations, the word criterion can require a minimum number of words to be contained in the audio portion. The minimum number of words may correspond to a translation unit, which is a minimum amount of content (c.g., words) that are used to render an effective interpretation in a translated language. In some implementations, the idiom criterion can require an entire idiom to be contained in the audio portion(s), such as is described with reference to FIG. 2B , above. In some implementations, the input duration criterion can require that the duration of the first audio portion be sufficient to account for linguistic differences between the two languages such as differences in grammar, or sentence structure, as described with reference to FIG. 2A, above. In some implementations, the processing duration criterion can require that the duration of the first audio portion be sufficient to account for an amount of time needed to generate (e.g., by the translator 156 of FIG. 1) a translation. In some implementations, the maximum delay criterion can require that a translation delay of the first audio portion (e.g., including the delays due to the input duration and processing duration) did not exceed a maximum delay between receiving the first audio portion in the first language from the first client device and providing the first audio portion in the second language to the second client device.

In some implementations, the one or more translation sufficiency criteria can bc based on a pairing between the first language and the second language. As described above with reference to FIG. 1 , languages that have more similarities in sentence structure, origins, culture, etc. are more likely to be more quickly translated than languages with less similarities. For example, because of the similarities between Spanish and Portugues, translation between a Spanish/Portugues pairing may be faster (e.g., a shorter delay) than translation between English and Japanese, which have much less similarities.

At operation 503, responsive to determining that the first audio portion satisfies the one or more translation sufficiency criteria, the processing logic causes the first audio portion to be translated into the second language. In some implementations, the processing logic causes the first audio portion to be provided to the translator 156 of FIG. 1 . In some implementations, the translator 156 may use one or more AI models, such as AI model 141 to generate a translation of the first audio portion. In some implementations, the translator 156 provides the first audio portion as input to an artificial intelligence (AI) model trained to translate speech in the first language into speech in the second language. In some implementations, the first audio portion in the first language has first prosodic elements, such as a volume, intonation, articulation, speed, pronunciation, style, cadence, emphasis, or the like.

At operation 504, the processing logic provides, to a second device of the second user, first synthesized speech in the second language, where the first synthesized speech is generated based on the first audio portion in the second language, and is associated with a second set of prosodic speech elements corresponding to the first set of prosodic speech elements. In some implementations, the first synthesized speech is obtained as an output from one or more of the translator 156 and/or an AI model 141. In some implementations, the output includes the first audio portion in the second language (also referred to as a "translated audio portion"). In some implementations, the first audio portion in the second language (e.g., the synthesized speech) has second prosodic elements that are based on the first prosodic elements. In some implementations, the first synthesized speech in the second language is provided to the second device as an overlay on the speech in the first language of the first audio portion. In some implementations, a first volume of the speech in the first language of the first audio portion is lower than a second volume of the first synthesized speech.

In some implementations, the translator 156, and/or the AI model 141 can generate synthesized speech in the second language as the output that is to be provided to the second user device. In some implementations, the translator 156 and/or the AI model 141 can generate a speech-to-speech or audio-to-audio translation with no conversion to or from text data in between. In some implementations, the translator 156 and/or the AI model 141 can generate captions from the translated audio portion to be displayed to users participating in the virtual meeting 121. In some implementations, the captions may be provided to a speaker who is being translated (e.g., the first user), along with an option to select between multiple translations to provide to those users that have requested translated audio (e.g., the second user).

Subsequently, in some implementations, the processing logic can receive a second audio portion and determine that the second audio portion docs not satisfy the one or more translation sufficiency criteria. In response, the processing logic can refrain from causing the second audio portion to be translated into the second language. Responsive to receiving a third audio portion, the processing logic can determine whether a combination of the second audio portion and the third audio portion satisfies the one or more translation sufficiency criteria. Responsive to determining that the combination of the second audio portion and the third audio portion satisfy the one or more translation sufficiency criteria, the processing logic can cause the combination of the second audio portion and the third audio portion to be translated into the second language. In some implementations, the processing logic can provide the combination of the second audio and the third audio as an input to the translator 156. In some implementations, the processing logic can provide the combination of the second audio and the third audio as an input to an AI model, such as the one or more AI models 141 of FIG. 1 . The processing logic can obtain one or more of second synthesized speech or a translated audio portion from one or more of the translator 156 and/or the AI model 141 as an output, and provide the output to a second device of the second user during the virtual meeting.

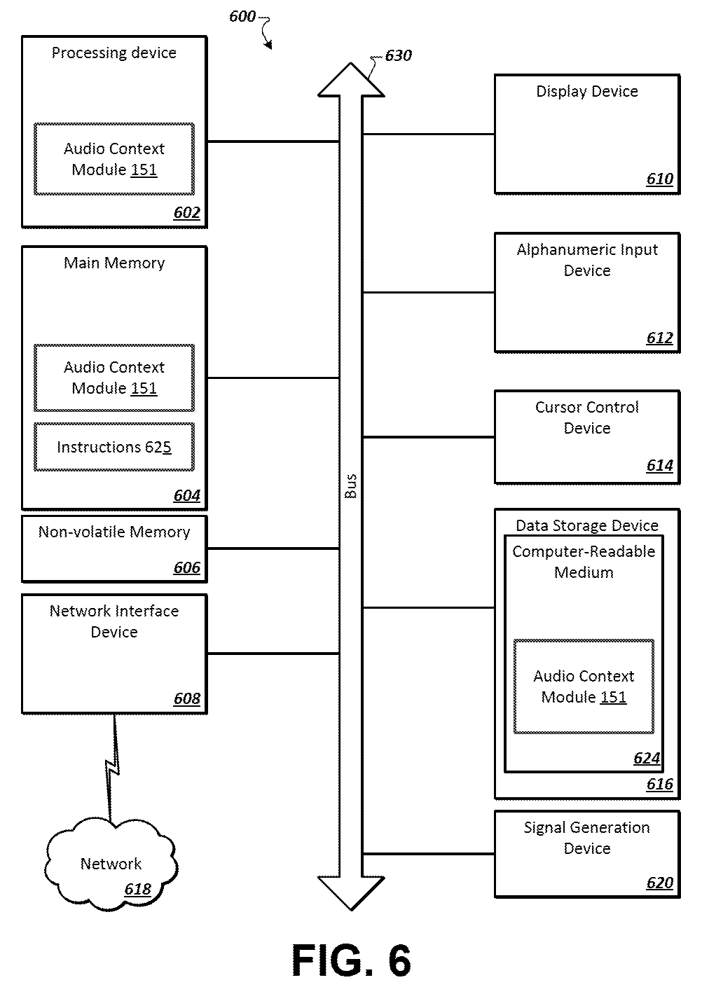

FIG. 6 is a block diagram illustrating an example of a computer system 600, according to aspects of the disclosure. The computer system 600 can correspond to virtual meeting platform 120 and/or client devices 102A-102N, described in FIG. 1 . Computer system 600 can operate in the capacity of a server or an endpoint machine in an endpoint-server network environment, or as a peer machine in a peer-to-peer (or distributed) network environment. The machine can bc a television, a personal computer (PC), a tablet PC, a set-top box (STB), a Personal Digital Assistant (PDA), a cellular telephone, a web appliance, a server, a network router, switch or bridge, or any machine capable of executing a set of instructions (sequential or otherwise) that specify actions to be taken by that machine. shall also be taken to include any collection of machines that individually or jointly execute a set (or multiple sets) of instructions to perform any one or more of the methodologies discussed herein. Further, while only a single machine is illustrated, the term "machine" shall also be taken to include any collection of machines that individually or jointly execute a set (or multiple sets) of instructions to perform any one or more of the methodologies discussed herein.

The computer system 600 includes a processing device 602 (e.g., a processor), a main memory 604 (e.g., read-only memory (ROM), flash memory, dynamic random access memory (DRAM) such as synchronous DRAM (SDRAM), double data rate (DDR) SDRAM, or DRAM (RDRAM), etc.), a non-volatile memory 606 (c.g., flash memory, static random access memory (SRAM), etc.), and a data storage device 616, which communicate with each other via a bus 630. In some implementations, the main memory 604 can be a non-transitory computer readable storage medium.

Processing device 602 represents one or more general-purpose processing devices such as a microprocessor, central processing unit, or the like. More specifically, processing device 602 can be a complex instruction set computing (CISC) microprocessor, reduced instruction set computing (RISC) microprocessor, very long instruction word (VLIW) microprocessor, or a processor implementing other instruction sets or processors implementing a combination of instruction sets. The processing device 602 can also be one or more special-purpose processing devices such as an application specific integrated circuit (ASIC), a field programmable gate array (FPGA), a digital signal processor (DSP), network processor, or the like. The processing device 602 is configured to execute network interface device 608 (e.g., for synchronizing data between platforms) for performing the operations discussed herein. The processing device 602 can be configured to execute instructions 625 stored in main memory 604. Non-volatile memory 606 can store the instructions 625 when they are not being executed, and can store additional system data that can be accessed by processing device 602.

The computer system 600 can further include a network interface device 608. The computer system 600 also can include a video display unit 610 (e.g., a liquid crystal display (LCD) or a cathode ray tube (CRT)), an input device 612 (c.g., a keyboard, and alphanumeric keyboard, a motion sensing input device, touch screen), a cursor control device 614 (e.g., a mouse), and a signal generation device 618 (e.g., a speaker).

The data storage device 616 can include a computer-readable storage medium 624 (e.g., a non-transitory machine-readable storage medium) on which is stored one or more sets of instructions 625 (e.g., for generating variations of a translated audio portion) embodying any one or more of the methodologies or functions described herein. The instructions can also reside, completely or at least partially, within the main memory 604 and/or within the one or more processing devices (e.g., the processing device 602) during execution thereof by the computer system 600, the main memory 604 and the processing device 602 also constituting machine- readable storage media. The instructions can further be transmitted or received over a network 620 via the network interface device 608. In some implementations, one or more processing devices can be operatively coupled to the main memory 604 to perform various operations.

While the computer-readable storage medium 624 (non-transitory computer-readable storage medium) is illustrated in an exemplary implementation to be a single medium, the terms "computer-readable storage medium" and "machine-readable storage medium" should be taken to include a single medium or multiple media (e.g., a centralized or distributed database, and/or associated caches and servers) that store the one or more sets of instructions. The terms "computer- readable storage medium" and "machine-readable storage medium" shall also be taken to include any medium that is capable of storing, encoding, or carrying a set of instructions for execution by the machine and that cause the machine to perform any one or more of the methodologies of the present disclosure. The terms "computer-readable storage medium" and "machine-readable storage medium" shall accordingly be taken to include, but not be limited to, solid-state memories, optical media, and magnetic media.

Reference throughout this specification to "one implementation," "one embodiment," "an implementation," or "an embodiment," means that a specific feature, structure, or characteristic described in connection with the implementation and/or embodiment is included in at least one implementation and/or embodiment. Thus, the appearances of the phrase "in one implementation," or "in an implementation," in various places throughout this specification can, but are not necessarily, referring to the same implementation, depending on the circumstances. Furthermore, the specific features, structures, or characteristics can bc combined in any suitable manner in one or more implementations.

To the extent that the terms "includes," "including," "has," "contains," variants thereof, and other similar words are used in either the detailed description or the claims, these terms are intended to be inclusive in a manner similar to the term "comprising" as an open transition word without precluding any additional or other elements.

As used in this application, the terms "component," "engine," "system," or the like are generally intended to refer to a computer-related entity, either hardware (e.g., a circuit), software, a combination of hardware and software, or an entity related to an operational machine with one or more specific functionalities. For example, a component can be, but is not limited to being, a process running on a processor (e.g., digital signal processor), a processor, an object, an executable, a thread of execution, a program, and/or a computer. By way of illustration, both an application running on a controller and the controller can be a component. One or more components can reside within a process and/or thread of execution and a component can be localized on one computer and/or distributed between two or more computers. Further, a "device" can come in the form of specially designed hardware; generalized hardware made specific by the execution of software thereon that enables hardware to perform specific functions (e.g., generating interest points and/or descriptors); software on a computer readable medium; or a combination thereof.

The aforementioned systems, circuits, engines, and SO on have been described with respect to interactions between several components and/or blocks. It can be appreciated that such systems, circuits, components, blocks, and so forth can include those components or specified sub- components, some of the specified components or sub-components, and/or additional components, and according to various permutations and combinations of the foregoing. Sub-components can also be implemented as components communicatively coupled to other components rather than included within parent components (hierarchical). Additionally, it should be noted that one or more components can be combined into a single component providing aggregate functionality or divided into several separate sub-components, and any one or more middle layers, such as a management layer, can be provided to communicatively couple to such sub-components in order to provide integrated functionality. Any components described herein can also interact with one or more other components not specifically described herein but known by those of skill in the art.

Moreover, the words "example" or "exemplary" are used herein to mean serving as an example, instance, or illustration. Any aspect or design described herein as "exemplary" is not necessarily to be construed as preferred or advantageous over other aspects or designs. Rather, use of the words "example" or "exemplary" is intended to present concepts in a concrete fashion. As used in this application, the term "or" is intended to mean an inclusive "or" rather than an exclusive "or." That is, unless specified otherwise, or clear from context, "X employs A or B" is intended to mean any of the natural inclusive permutations. That is, if X employs A; X employs B; or X employs both A and B, then "X employs A or B" is satisfied under any of the foregoing instances. In addition, the articles "a" and "an" as used in this application and the appended claims should generally be construed to mean "one or more" unless specified otherwise or clear from context to be directed to a singular form.

Finally, implementations described herein include collection of data describing a user and/or activities of a user. In one implementation, such data is only collected upon the user providing consent to the collection of this data. In some implementations, a user is prompted to explicitly allow data collection. Further, the user can opt-in or opt-out of participating in such data collection activities. In one implementation, the collected data is anonymized prior to performing any analysis to obtain any statistical patterns so that the identity of the user cannot bc determined from the collected data.

What is claimed is:

1. A method comprising:
receiving, during a virtual meeting, a sequence of media stream portions from a first device of a first user of a plurality of users participating in a virtual meeting, wherein the sequence of media stream portions comprises a first sequence of audio portions reflecting speech in a first language, wherein the speech in the first language is to be translated to a second language for a second user of the plurality of users participating in the virtual meeting, wherein audio portions of the first sequence are each received at respective time points during the virtual meeting;
responsive to receiving a first audio portion of the sequence of audio portions at a first time point during the virtual meeting, determining whether the first audio portion satisfies one or more translation sufficiency criteria;
responsive to determining that the first audio portion satisfies the one or more translation sufficiency criteria, causing the first audio portion to be translated into the second language, wherein speech in the first audio portion is associated with a first set of prosodic speech elements; and
providing, to a second device of the second user, first synthesized speech in the second language, wherein the first synthesized speech is generated based on the first audio portion in the second language, and is associated with a second set of prosodic speech elements corresponding to the first set of prosodic speech elements.

2. The method of claim 1, further comprising:
responsive to receiving a second audio portion of the sequence of audio portions at a second time point during the virtual meeting, determining whether the second audio portion satisfies the one or more translation sufficiency criteria;
responsive to determining that the second audio portion does not satisfy the one or more translation sufficiency criteria:
refraining from causing the second audio portion to be translated into the second language;
responsive to receiving a third audio portion at a third time point during the virtual meeting, determining whether a combination of the second audio portion and the third audio portion satisfies the one or more translation sufficiency criteria;
responsive to determining that the combination of the second audio portion and the third audio portion satisfies the one or more translation sufficiency criteria, causing the combination of the second audio portion and the third audio portion to be translated into the second language, wherein speech in the combination of the second audio portion and the third audio portion is associated with a third set of prosodic speech elements; and
providing, to the second device of the second user, second synthesized speech in the second language, wherein the second synthesized speech is generated based on the combination of the second audio portion and the third audio portion in the second language, and is associated with a fourth set of prosodic speech elements corresponding to the third set of prosodic speech elements.

3. The method of claim 2, wherein the one or more translation sufficiency criteria comprise at least one of: a word criterion, an idiom criterion, an input duration criterion, a processing duration criterion, or a maximum delay criterion.

4. The method of claim 1, wherein the one or more translation sufficiency criteria are based on a pairing between the first language and the second language.

5. The method of claim 1, wherein the first synthesized speech is provided to the second device as an overlay on the speech in the first language of the first audio portion.

6. The method of claim 5, wherein a first volume of the speech in the first language of the first audio portion is lower than a second volume of the first synthesized speech in the second language.

7. The method of claim 1, wherein causing the first audio portion to be translated into the second language comprises:
providing the first audio portion as a first input to an artificial intelligence (AI) model trained to translate speech in the first language into speech in the second language; and
obtaining a first output of the AI model, the first output comprising at least one of a first translated audio portion or the first synthesized speech.

8. A system comprising:
a memory;
one or more processing devices operatively coupled to the memory, the one or more processing devices to perform operations comprising:
receiving, during a virtual meeting, a sequence of media stream portions from a first device of a first user of a plurality of users participating in a virtual meeting, wherein the sequence of media stream portions comprises a first sequence of audio portions reflecting speech in a first language, wherein the speech in the first language is to be translated to a second language for a second user of the plurality of users participating in the virtual meeting, wherein audio portions of the first sequence are each received at respective time points during the virtual meeting;
responsive to receiving a first audio portion of the sequence of audio portions at a first time point during the virtual meeting, determining whether the first audio portion satisfies one or more translation sufficiency criteria;
responsive to determining that the first audio portion satisfies the one or more translation sufficiency criteria, causing the first audio portion to be translated into the second language, wherein speech in the first audio portion is associated with a first set of prosodic speech elements; and
providing, to a second device of the second user, first synthesized speech in the second language, wherein the first synthesized speech is generated based on the first audio portion in the second language, and is associated with a second set of prosodic speech elements corresponding to the first set of prosodic speech elements.

9. The system of claim 8, the operations further comprising:
responsive to receiving a second audio portion of the sequence of audio portions at a second time point during the virtual meeting, determining whether the second audio portion satisfies the one or more translation sufficiency criteria;
responsive to determining that the second audio portion does not satisfy the one or more translation sufficiency criteria:
refraining from causing the second audio portion to be translated into the second language;
responsive to receiving a third audio portion at a third time point during the virtual meeting, determining whether a combination of the second audio portion and the third audio portion satisfies the one or more translation sufficiency criteria;
responsive to determining that the combination of the second audio portion and the third audio portion satisfies the one or more translation sufficiency criteria, causing the combination of the second audio portion and the third audio portion to be translated into the second language wherein speech in the combination of the second audio portion and the third audio portion is associated with a third set of prosodic speech elements; and
providing, to the second device of the second user, second synthesized speech in the second language, wherein the second synthesized speech is generated based on the combination of the second audio portion and the third audio portion in the second language, and is associated with a fourth set of prosodic speech elements corresponding to the third set of prosodic speech elements.

10. The system of claim 9, wherein the one or more translation sufficiency criteria comprise at least one of: a word criterion, an idiom criterion, an input duration criterion, a processing duration criterion, or a maximum delay criterion.

11. The system of claim 8, wherein the one or more translation sufficiency criteria are based on a pairing between the first language and the second language.

12. The system of claim 8, wherein the first synthesized speech is provided to the second device as an overlay on the speech in the first language of the first audio portion.

13. The system of claim 12, wherein a first volume of the speech in the first language of the first audio portion is lower than a second volume of the first synthesized speech in the second language.

14. The system of claim 8, wherein causing the first audio portion to be translated into the second language comprises:
providing the first audio portion as a first input to an artificial intelligence (AI) model trained to translate speech in the first language into speech in the second language; and
obtaining a first output of the AI model, the first output comprising at least one of a first translated audio portion or the first synthesized speech.

15. A non-transitory computer-readable storage medium comprising instructions, that when executed by one or more processing devices cause a server to perform operations comprising:
receiving, during a virtual meeting, a sequence of media stream portions from a first device of a first user of a plurality of users participating in a virtual meeting, wherein the sequence of media stream portions comprises a first sequence of audio portions reflecting speech in a first language, wherein the speech in the first language is to be translated to a second language for a second user of the plurality of users participating in the virtual meeting, wherein audio portions of the first sequence each received at respective time points during the virtual meeting;
responsive to receiving a first audio portion of the sequence of audio portions at a first time point during the virtual meeting, determining whether the first audio portion satisfies one or more translation sufficiency criteria;
responsive to determining that the first audio portion satisfies the one or more translation sufficiency criteria, causing the first audio portion to be translated into the second language, wherein speech in the first audio portion is associated with a first set of prosodic speech elements; and
providing, to a second device of the second user, first synthesized speech in the second language, wherein the first synthesized speech generated based on the first audio portion in the second language, and is associated with a second set of prosodic speech elements corresponding to the first set of prosodic speech elements.

16. The non-transitory computer-readable storage medium of claim 15, the operations further comprising:
responsive to receiving a second audio portion of the sequence of audio portions at a second time point during the virtual meeting, determining whether the second audio portion satisfies the one or more translation sufficiency criteria;
responsive to determining that the second audio portion does not satisfy the one or more translation sufficiency criteria:
refraining from causing the second audio portion to be translated into the second language;
responsive to receiving a third audio portion at a third time point during the virtual meeting, determining whether a combination of the second audio portion and the third audio portion satisfies the one or more translation sufficiency criteria;
responsive to determining that the combination of the second audio portion and the third audio portion satisfies the one or more translation sufficiency criteria, causing the combination of the second audio portion and the third audio portion to be translated into the second language wherein speech in the combination of the second audio portion and the third audio portion is associated with a third set of prosodic speech elements; and
providing, to the second device of the second user, second synthesized speech in the second language, wherein the second synthesized speech is generated based on the combination of the second audio portion and the third audio portion in the second language, and is associated with a fourth set of prosodic speech elements corresponding to the third set of prosodic speech elements.

17. The non-transitory computer-readable storage medium of claim 16, wherein the one or more translation sufficiency criteria comprise at least one of: a word criterion, an idiom criterion, an input duration criterion, a processing duration criterion, or a maximum delay criterion.

18. The non-transitory computer-readable storage medium of claim 15, wherein the one or more translation sufficiency criteria are based on a pairing between the first language and the second language.

19. The non-transitory computer-readable storage medium of claim 15, wherein the first synthesized speech is provided to the second device as an overlay on the speech in the first language of the first audio portion, and wherein a first volume of the speech in the first language of the first audio portion is lower than a second volume of the first synthesized speech in the second language.

20. The non-transitory computer-readable storage medium of claim 15, wherein causing the first audio portion to be translated into the second language comprises:
providing the first audio portion as a first input to an artificial intelligence (AI) model trained to translate speech in the first language into speech in the second language; and
obtaining a first output of the AI model, the first output comprising at least one of a first translated audio portion or the first synthesized speech.
